(19) United States
(12) Patent Application Publication
(10) Pub. No.: US 2026/0361102 A1
(43) Pub. Date: Nov. 12, 2026

(54) Energy Balancing System and Energy Storage System

(71) Applicant: Huawei Digital Power Technologies Co., Ltd., Shenzhen (CN)

(72) Inventors: Wanxiang Ye, Dongguan (CN); Ping Li, Shenzhen (CN); Shijiang Yu, Shanghai (CN); Chong Wei, Dongguan (CN)

(73) Assignee: Huawei Digital Power Technologies Co., Ltd., Shenzhen (CN)

(21) Appl. No.: 19/727,297

(22) Filed: Jul. 1, 2026

Related U.S. Application Data
(63) Continuation of application No. PCT/CN2024/138241, filed on Dec. 10, 2024.

(30) Foreign Application Priority Data
Jan. 2, 2024 (CN) 202410008089.X

(51) Int. Cl. H02J 7/56; H02J 7/50; H02J 7/82

(52) U.S. Cl. CPC H02J 7/56; H02J 7/575; H02J 7/82; H02J 2207/20

(57) ABSTRACT

An energy balancing system is disposed outside an energy storage apparatus. The energy balancing system includes at least two balancing circuits. In a same time period, a first balancing circuit is configured to perform discharging processing on a first energy storage unit, and a second balancing circuit is configured to perform charging processing on a second energy storage unit, to implement energy balancing between energy storage units in the energy storage apparatus. In addition, a switching circuit disposed in the energy balancing system can implement sharing of a balancing circuit between energy storage units.

### CROSS-REFERENCE TO RELATED APPLICATIONS

This is a continuation of International Patent Application No. PCT/CN2024/138241, filed on Dec. 10, 2024, which claims priority to Chinese Patent Application No. 202410008089.X, filed on Jan. 2, 2024, which are both incorporated by reference.

### TECHNICAL FIELD

This disclosure relates to the field of energy technologies, and in particular, to an energy balancing system and an energy storage system.

### BACKGROUND

A scale of an energy storage system is gradually expanding. In an example energy storage system, a single battery cluster may need more than 400 cells connected in series. In addition, a capacity of a single cell has exceeded 300 ampere-hours (Ah). During a design of the energy storage system, because the single battery cluster has a large capacity and a heavy weight, an integrator of the energy storage system may divide the single battery cluster into a plurality of battery packs for design. A capacity of a battery pack is affected by discreteness of a factory capacity of a cell, process deviation, temperature control deviation between battery packs, and a difference between cell attenuation rates. During application, a battery capacity of the battery cluster is affected by a battery pack with a weakest state of health (SOH), accelerating capacity attenuation of the battery cluster. Therefore, an active balancing module at a cell level or a battery pack level may be added to reduce impact of a weakest battery pack and improve a discharge capacity of a battery cluster in a life cycle. In an active balancing solution, an active balancing module is added to each battery pack or each cell, utilization of an active balancing function of the active balancing module is low, and energy balancing costs are high.

### SUMMARY

This disclosure provides an energy balancing system and an energy storage system, to improve utilization of an active balancing function and reduce energy balancing costs.

According to a first aspect, an embodiment of this disclosure provides an energy balancing system, including a first balancing circuit, a second balancing circuit, a first switching circuit, a second switching circuit, and a balancing busbar. The first switching circuit is connected to a first side of the first balancing circuit, and a second side of the first balancing circuit is connected to the balancing busbar. The second switching circuit is connected to a first side of the second balancing circuit, and a second side of the second balancing circuit is connected to the balancing busbar. Both the first switching circuit and the second switching circuit are configured to connect to positive electrodes and negative electrodes of energy storage units connected in series in the energy storage apparatus. During active energy balancing, the first switching circuit is configured to connect a positive electrode and a negative electrode of a first energy storage unit to the first side of the first balancing circuit, so that the first balancing circuit performs discharging processing on the first energy storage unit; and the second switching circuit is configured to connect a positive electrode and a negative electrode of a second energy storage unit to the first side of the second balancing circuit, so that the second balancing circuit performs charging processing on the second energy storage unit.

In this disclosure, the energy balancing system is disposed outside the energy storage apparatus. The energy balancing system includes at least two balancing circuits. In a same time period, the first balancing circuit is configured to perform discharging processing on the first energy storage unit, and the second balancing circuit is configured to perform charging processing on the second energy storage unit, to implement energy balancing between the energy storage units in the energy storage apparatus. In addition, a switching circuit disposed in the energy balancing system can implement sharing of a balancing circuit between energy storage units, thereby improving utilization of the balancing circuit and reducing energy balancing costs. Moreover, in the energy balancing system, a large-power balancing circuit is used to replace a balancing module disposed in each energy storage unit, so that energy balancing costs can be reduced, balancing power can be increased, and a balancing time can be shortened.

In some embodiments of this disclosure, to achieve energy balancing effect, an average state of charge (SOC) value of the energy storage units may be used as a target SOC value. An SOC value of the first energy storage unit is greater than the target SOC value, for example, the first energy storage unit is any energy storage unit whose SOC value is greater than the target SOC value, and an SOC value of the second energy storage unit is less than the target SOC value, for example, the second energy storage unit is any energy storage unit whose SOC value is less than the target SOC value. The first balancing circuit is used to use a part of energy that is in the first energy storage unit and that is greater than the target SOC value to charge the second energy storage unit, to achieve energy balancing effect.

In some embodiments of this disclosure, the energy balancing system may further include a balancing controller. The balancing controller is configured to: control on and off states of the first switching circuit and the second switching circuit, control a discharging state of the first balancing circuit, and control a charging state of the second balancing circuit. The balancing controller may control the first switching circuit to connect a positive electrode and a negative electrode of a discharging energy storage unit to the first side of the first balancing circuit, and control the second switching circuit to connect a positive electrode and a negative electrode of a charging energy storage unit to the second balancing circuit. The first energy storage unit is any energy storage unit, in the energy storage apparatus, whose SOC value is greater than the target SOC value, and the second energy storage unit is any energy storage unit, in the energy storage apparatus, whose SOC value is less than the target SOC value. The balancing controller may further control the first balancing circuit to perform discharging processing on the first energy storage unit, and control the second balancing circuit to perform charging processing on the second energy storage unit.

In this embodiment of this disclosure, the first switching circuit includes a plurality of pairs of first switches, and a quantity of pairs of first switches is the same as a quantity of energy storage units. One side of a pair of first switches is connected to a positive output end and a negative output end of a corresponding energy storage unit, and the other side of the pair of first switches is connected to a positive electrode and a negative electrode of the first side of the first balancing circuit. In a same time period, a pair of first switches is turned on, and other pairs of first switches are turned off. The first balancing circuit discharges, to the balancing busbar, electric energy of the first energy storage unit connected to the turned-on first switches. Similarly, the second switching circuit includes a plurality of pairs of second switches, and a quantity of pairs of second switches is the same as the quantity of energy storage units. One side of a pair of second switches is connected to a positive output end and a negative output end of a corresponding energy storage unit, and the other side of the pair of second switches is connected to a positive electrode and a negative electrode of the first side of the second balancing circuit. In a same time period, a pair of second switches is turned on, and other pairs of second switches are turned off. The second balancing circuit uses electric energy on the balancing busbar to charge the second energy storage unit connected to the turned-on second switches.

In some embodiments of this disclosure, when SOC values of a plurality of energy storage units in the energy storage apparatus are all greater than the target SOC value, it may be considered that there are a plurality of energy storage units that need to be discharged in the energy storage apparatus. When SOC values of a plurality of energy storage units in the energy storage apparatus are all less than the target SOC value, it may be considered that there are a plurality of energy storage units that need to be charged in the energy storage apparatus.

In this embodiment of this disclosure, in a discharging process for energy balancing, in a same time period, the first switching circuit is connected to only a positive electrode and a negative electrode of one energy storage unit, namely, the first energy storage unit. Therefore, the first balancing circuit performs discharging processing on only one energy storage unit, namely, the first energy storage unit. When a difference between the SOC value of the first energy storage unit and the target SOC value is less than a first threshold, it indicates that energy of the first energy storage unit has reached a balancing standard, and the first switching circuit may switch to connect a positive electrode and a negative electrode of another energy storage unit, namely, the third energy storage unit, to the first side of the first balancing circuit, so that the first balancing circuit performs discharging processing on the third energy storage unit. An SOC value of the third energy storage unit is greater than the target SOC value.

In some embodiments of this disclosure, in the foregoing discharging process for energy balancing, a discharging priority of the energy storage units may be determined based on differences between the target SOC value and the SOC values of the energy storage units. For example, a larger difference between an SOC value of an energy storage unit and the target SOC value indicates a higher discharging priority of the energy storage unit. In other words, the energy storage unit undergoes an energy balancing operation preferentially. For example, in the foregoing process, the difference between the SOC value of the first energy storage unit and the target SOC value is greater than a difference between the SOC value of the third energy storage unit and the target SOC value. Therefore, the first balancing circuit preferentially performs discharging processing on the first energy storage unit.

After all energy storage units whose SOC values are greater than the target SOC value are discharged until differences between the SOC values and the target SOC value are less than the first threshold, it indicates that energy balancing for all these energy storage units is completed. In this case, the first switching circuit may switch to an off state, for example, the first switching circuit does not connect any energy storage unit to the first side of the first balancing circuit.

In this embodiment of this disclosure, in a charging process for energy balancing, in a same time period, the second switching circuit is connected to only a positive electrode and a negative electrode of one energy storage unit, namely, the second energy storage unit. Therefore, the second balancing circuit performs charging processing on only one energy storage unit, namely, the second energy storage unit. When a difference between the SOC value of the second energy storage unit and the target SOC value is less than a second threshold, it indicates that energy of the second energy storage unit has reached the balancing standard, and the second switching circuit may switch to connect a positive electrode and a negative electrode of another energy storage unit, namely, a fourth energy storage unit, to the first side of the second balancing circuit, so that the second balancing circuit performs charging processing on the fourth energy storage unit. An SOC value of the fourth energy storage unit is less than the target SOC value, and the second threshold may be the same as or different from the first threshold. This is not limited herein.

In some embodiments of this disclosure, in the foregoing charging process for energy balancing, a charging priority of the energy storage units may be determined based on the differences between the target SOC value and the SOC values of the energy storage units. For example, a larger difference between an SOC value of an energy storage unit and the target SOC value indicates a higher charging priority of the energy storage unit. In other words, the energy storage unit undergoes an energy balancing operation preferentially. For example, in the foregoing process, the difference between the SOC value of the second energy storage unit and the target SOC value is greater than a difference between the SOC value of the fourth energy storage unit and the target SOC value. Therefore, the second balancing circuit preferentially performs charging processing on the second energy storage unit.

After all energy storage units whose SOC values are less than the target SOC value are charged until differences between the SOC values and the target SOC value are less than the second threshold, it indicates that energy balancing for all these energy storage units is completed. In this case, the second switching circuit may switch to an off state, for example, the second switching circuit does not connect any energy storage unit to the first side of the second balancing circuit.

In some other embodiments of this disclosure, if there are a large quantity of energy storage units connected in series in the energy storage apparatus connected to the energy balancing system, to improve active balancing power and active balancing efficiency, a quantity of balancing circuits can be appropriately increased in the energy balancing system.

For example, the energy balancing system may include a plurality of first balancing circuits and a plurality of first switching circuits, and the first switching circuits and the first balancing circuits are disposed in a one-to-one correspondence. In a time period during active balancing, to improve active balancing power and active balancing efficiency, the balancing controller can simultaneously control different first switching circuits to connect positive electrodes and negative electrodes of different discharging energy storage units to first sides of corresponding first balancing circuits, and control the corresponding first balancing circuits to perform discharging processing on the different first energy storage units. For example, during active balancing, two first switching circuits may be respectively used to respectively connect two first balancing circuits to two different first energy storage units, and the two first balancing circuits may simultaneously discharge electric energy stored in the two first energy storage units to the balancing busbar. In another time period during active balancing, if required active balancing power and efficiency are low, the balancing controller may alternatively control only one first switching circuit to connect a positive electrode and a negative electrode of one discharging energy storage unit to a first side of one first balancing circuit, and control one first balancing circuit to perform discharging processing on one first energy storage unit.

For example, the energy balancing system may include a plurality of second balancing circuits and a plurality of second switching circuits, and the second switching circuits and the second balancing circuits are disposed in a one-to-one correspondence. In a time period during active balancing, to improve active balancing power and active balancing efficiency, the balancing controller may simultaneously control different second switching circuits to connect positive electrodes and negative electrodes of different charging energy storage units to first sides of corresponding second balancing circuits, and control the corresponding second balancing circuits to perform charging processing on the different first energy storage units. For example, during active balancing, two second switching circuits may be respectively used to respectively connect two second balancing circuits to two different second energy storage units, and the two second balancing circuits may simultaneously discharge electric energy stored in the two second energy storage units to the balancing busbar. In another time period during active balancing, if required active balancing power and efficiency are low, the balancing controller may alternatively control only one second switching circuit to connect a positive electrode and a negative electrode of one charging energy storage unit to a first side of one second balancing circuit, and control one second balancing circuit to perform charging processing on one second energy storage unit.

In this disclosure, to simplify charging and discharging management control logic of the balancing controller for different energy storage units, a quantity of first balancing circuits included in the energy balancing system is usually the same as a quantity of second balancing circuits.

In some embodiments of this disclosure, the first balancing circuit and the second balancing circuit may include a unidirectional direct current-direct current (DC-DC) circuit. In other words, the first balancing circuit implements only a discharging function, and the second balancing circuit implements only a charging function. Alternatively, in some other embodiments of this disclosure, the first balancing circuit and the second balancing circuit may alternatively include a bidirectional DC-DC circuit. For example, functions of the first balancing circuit and the second balancing circuit may be interchanged, to implement the discharging function and the charging function.

In some embodiments of this disclosure, the energy balancing system may be configured as a balancing control box independent of the energy storage apparatus.

In some other embodiments of this disclosure, an energy storage controller, for example, a battery control unit, may be further disposed in the balancing control box, for example, the energy balancing system. The energy storage controller is configured to detect the SOC values of the energy storage units, and may sample a state of charge by using a battery sampling unit disposed in each energy storage unit. The energy storage controller may determine the target SOC value based on the SOC values of the energy storage units, where the target SOC value may be an average of the SOC values of the energy storage units, and the average is also referred to as a median value. The energy storage controller may control a status of the energy storage apparatus based on information such as the SOC values of the energy storage units, for example, may control the energy storage apparatus to be in a charging state, a discharging state, or a standby state. The energy storage controller may further determine the differences between the target SOC value and the SOC values of the energy storage units. When some differences are large, for example, greater than a threshold, for example, an active balancing condition is met, the energy storage controller starts an active balancing procedure. The energy storage controller determines the first energy storage unit and the second energy storage unit from the energy storage units based on the target SOC value, and delivers information about the first energy storage unit and the second energy storage unit to the balancing controller, so that the balancing controller performs an active balancing operation. The first energy storage unit is an energy storage unit whose SOC value is greater than the target SOC value, and the second energy storage unit is an energy storage unit whose SOC value is less than the target SOC value.

According to a second aspect, this disclosure provides an energy storage system. The energy storage system may include the energy balancing system and the energy storage apparatus according to any possible design of the first aspect. The energy storage apparatus includes a plurality of energy storage units connected in series, and positive electrodes and negative electrodes of the energy storage units are respectively connected to a first switching circuit and a second switching circuit in the energy balancing system.

The energy storage system provided in this embodiment of this disclosure may be a commercial power station energy storage system, or may be a scenario that has a battery requirement, such as an industrial and commercial energy storage system, a residential energy storage system, a power station energy storage system, or a charging station energy storage system. In addition, this disclosure is applicable to various forms of batteries such as a lithium-ion battery, a sodium-ion battery, and a magnesium-aluminum battery.

In some embodiments of this disclosure, the system may be applied to active balancing at a battery pack level. Correspondingly, the energy storage apparatus may be a battery cluster, and the energy storage unit is a battery pack, for example, a plurality of battery packs connected in series form a battery cluster. The energy balancing system provided in this embodiment of this disclosure is disposed outside the battery pack, and the energy balancing system can implement energy balancing between battery packs.

In some other embodiments of this disclosure, the system may be applied to active balancing at a cell level. Correspondingly, the energy storage apparatus may be a battery pack, and the energy storage unit is a cell, for example, a plurality of cells connected in series form a battery pack. The energy balancing system provided in this embodiment of this disclosure is disposed outside a cell, and the energy balancing system can implement energy balancing between cells.

For technical effect that can be achieved by any possible design in the second aspect, refer to the technical effect that can be achieved by any possible design in the first aspect. Details are not described herein again. These aspects or another aspect of this disclosure is clearer and more comprehensible in descriptions of the following embodiments.

### BRIEF DESCRIPTION OF DRAWINGS

FIG. 1 is a diagram of a structure of an energy storage system.

FIG. 2 is a diagram of a structure of a battery cluster.

FIG. 3 is a diagram of a structure of energy balancing at a battery pack level.

FIG. 4 is a diagram of a structure of an energy balancing system according to an embodiment of this disclosure.

FIG. 5 is diagram of another structure of an energy balancing system according to an embodiment of this disclosure.

FIG. 6 is a diagram of SOC values of energy storage units according to an disclosure.

FIG. 7A and FIG. 7B are a diagram of an energy balancing process of an energy balancing system according to an embodiment.

### DETAILED DESCRIPTION

To make the objectives, technical solutions, and advantages of this disclosure clearer, the following further describes this disclosure in detail with reference to the accompanying drawings.

Terms used in the following embodiments are merely intended to describe embodiments, but are not intended to limit this disclosure. The terms “one”, “a”, “the”, “the foregoing”, “this”, and “the one” of singular forms used in this specification and the appended claims of this disclosure are also intended to include expressions such as “one or more”, unless otherwise specified in the context clearly.

Reference to “an embodiment”, “some embodiments”, or the like described in this specification indicates that one or more embodiments of this disclosure include a feature, structure, or characteristic described with reference to embodiments. Therefore, statements such as “in an embodiment”, “in some embodiments”, “in some other embodiments”, and “in other embodiments” that appear at different places in this specification do not necessarily mean reference to a same embodiment. Instead, the statements mean “one or more but not all of embodiments”, unless otherwise emphasized in another manner. The terms “include”, “have”, “contain”, and their variants all mean “include but are not limited to”, unless otherwise emphasized in another manner.

In addition, same reference numerals in the figures represent same or similar structures. Therefore, repeated description thereof is omitted. Expressions of locations and directions in this disclosure are described by using the accompanying drawings as an example. However, changes may also be made, and all the changes fall within the protection scope of this disclosure. The accompanying drawings in this disclosure are merely used to illustrate relative location relationships and do not represent an actual scale.

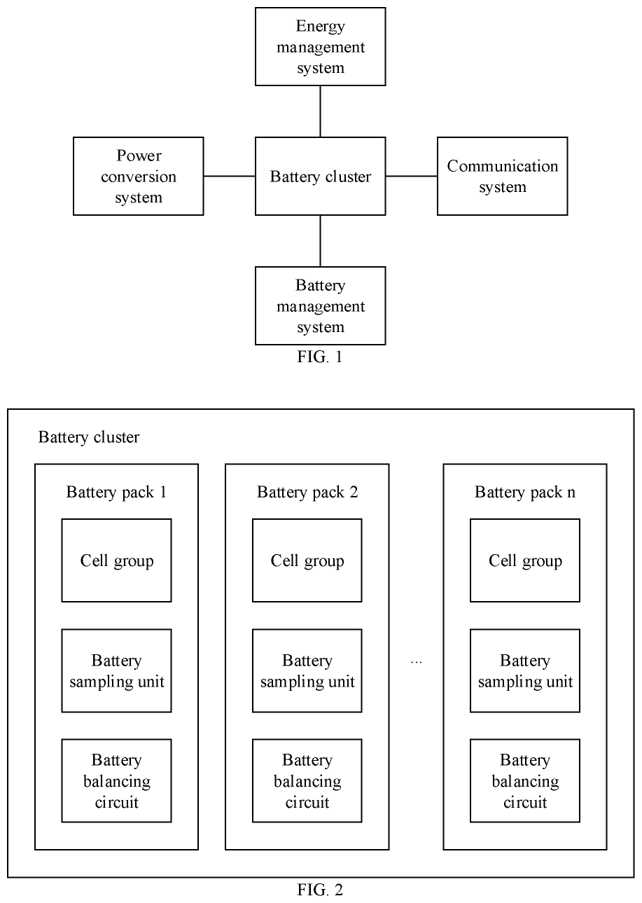

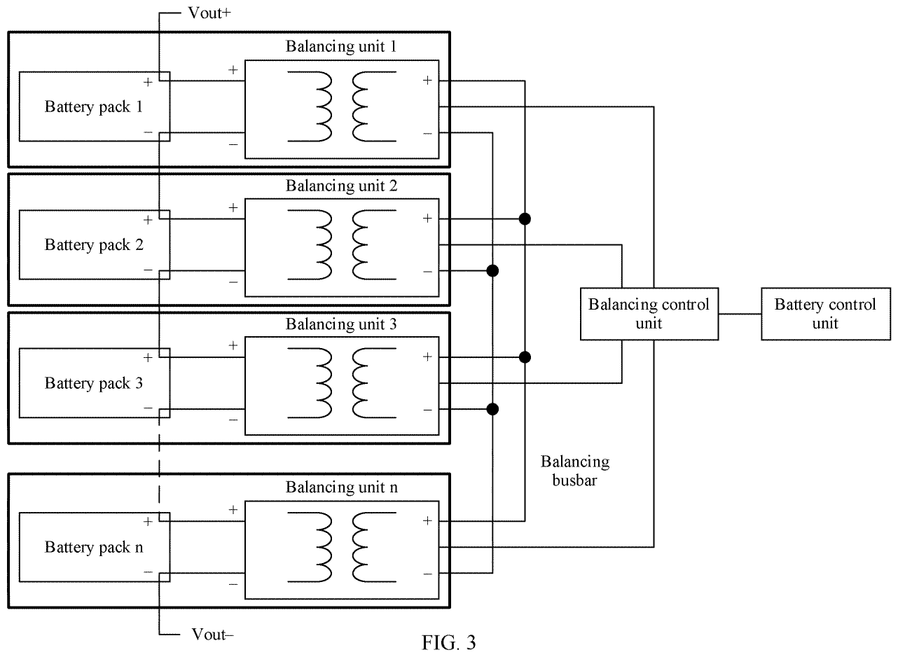

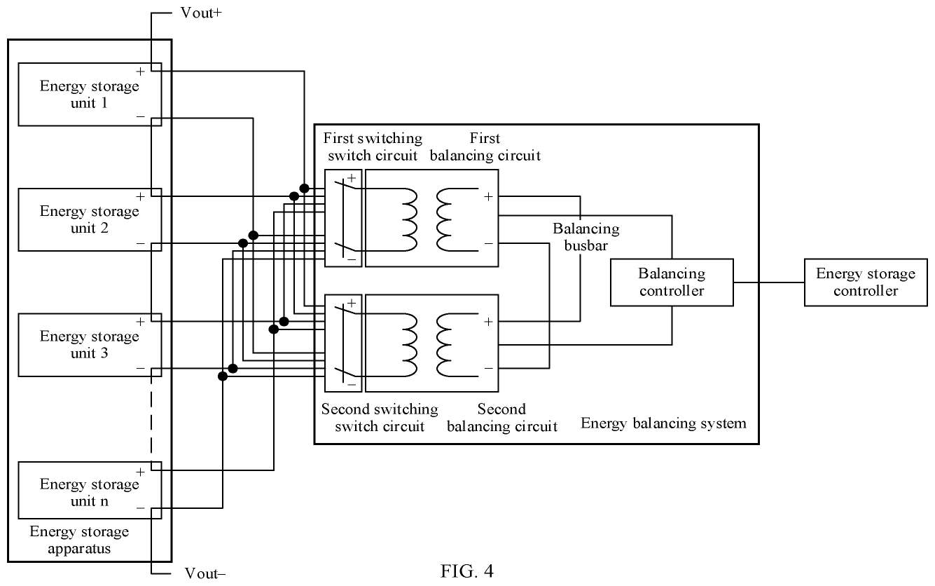

Refer to FIG. 1. An energy storage system used for industrial and commercial use or a power station usually includes core components such as a battery cluster, a battery management system, a power conversion system, an energy management system, and a communication system. Refer to FIG. 2. The battery cluster may include one or more battery packs, and the battery pack usually includes a cell group, a battery sampling unit, a battery balancing circuit, and the like. The battery sampling unit and the battery control unit may form the battery management system, and a battery control unit may control the battery sampling unit to sample a state of charge of the cell group. For battery packs having different SOHs and SOCs in the battery cluster, to implement a purpose that the battery packs can be fully charged or fully discharged at the same time, energy balancing between the battery packs needs to be performed, and this part of work is completed by the battery balancing circuit. Refer to FIG. 3. An example active balancing solution at a battery pack level is as follows: A balancing unit (for example, the battery balancing circuit) is added in each battery pack. When the battery control unit determines, based on SOC values that are of cell groups in battery packs and that are obtained by using battery sampling units, that energy balancing is required between the battery packs, a balancing control unit controls a balancing unit in a battery pack with a high state of charge to discharge to a balancing busbar and controls a balancing unit in a battery pack with a low SOC to draw electricity from the balancing busbar. Finally, SOCs of the battery packs are relatively consistent, and the battery packs are fully charged or fully discharged at the same time, so that utilization of the battery cluster is maximized.

An example active balancing solution at the battery pack level may have the following disadvantages: 1. A balancing unit is deployed in a battery pack. During use of the battery pack in a life cycle, SOH and SOC differences between the battery packs are not obvious in middle and early stages of use. Therefore, most balancing units do not work in the middle and early stages of an energy storage system, and resources are wasted to some extent. 2. If a balancing unit does not work for a long time, reliability problems such as component aging and circuit aging may occur. 3. A balancing unit is affected by a quantity of battery packs. As the quantity of battery packs increases, costs increase, and return on investment is low. 4. An example energy storage system may use liquid cooling. When a balancing unit in a battery pack is faulty, a waterproof housing needs to be opened to replace the balancing unit. This causes heavy maintenance workload and brings a sealing risk.

To improve utilization of an active balancing function and reduce energy balancing costs, this disclosure provides an energy balancing system and an energy storage system. The following describes in detail the energy balancing system and the energy storage system provided in this disclosure with reference to the accompanying drawings.

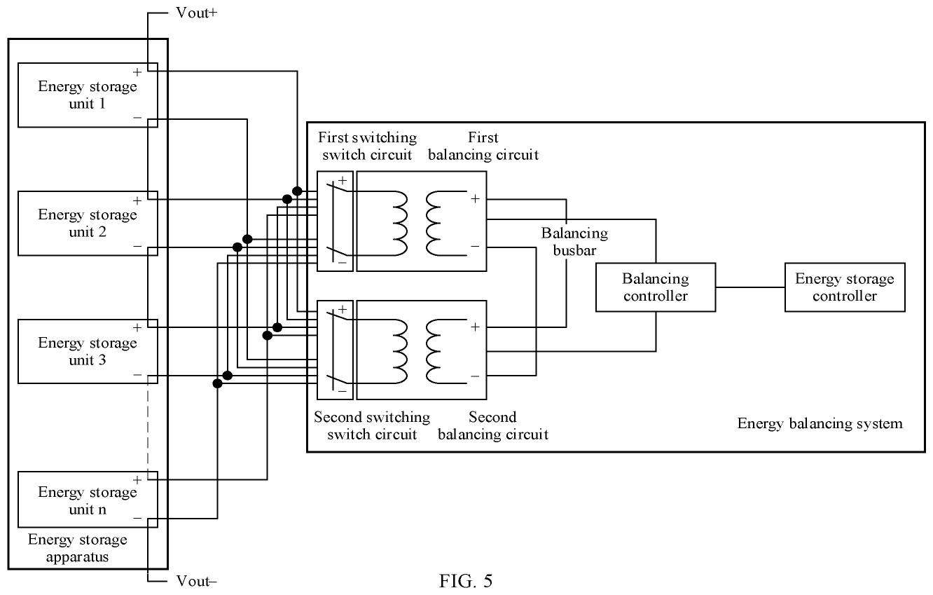

Refer to FIG. 4. In an embodiment of this disclosure, the energy balancing system includes a first balancing circuit, a second balancing circuit, a first switching circuit, a second switching circuit, and a balancing busbar. The first switching circuit is connected to a first side of the first balancing circuit, and a second side of the first balancing circuit is connected to the balancing busbar. The second switching circuit is connected to a first side of the second balancing circuit, and a second side of the second balancing circuit is connected to the balancing busbar. Both the first switching circuit and the second switching circuit are configured to connect to positive electrodes and negative electrodes of energy storage units connected in series in the energy storage apparatus. During active energy balancing, the first switching circuit is configured to connect a positive electrode and a negative electrode of a first energy storage unit to the first side of the first balancing circuit, so that the first balancing circuit performs discharging processing on the first energy storage unit; and the second switching circuit is configured to connect a positive electrode and a negative electrode of a second energy storage unit to the first side of the second balancing circuit, so that the second balancing circuit performs charging processing on the second energy storage unit.

In addition, to achieve energy balancing effect, an average SOC value of the energy storage units may be used as a target SOC value. An SOC value of the first energy storage unit is greater than the target SOC value, for example, the first energy storage unit is any energy storage unit whose SOC value is greater than the target SOC value, and an SOC value of the second energy storage unit is less than the target SOC value, for example, the second energy storage unit is any energy storage unit whose SOC value is less than the target SOC value. The first balancing circuit is used to use a part of energy that is in the first energy storage unit and that is greater than the target SOC value to charge the second energy storage unit, to achieve energy balancing effect.

Refer to FIG. 4. In some embodiments of this disclosure, the energy balancing system may further include a balancing controller. The balancing controller is configured to: control on and off states of the first switching circuit and the second switching circuit, control a discharging state of the first balancing circuit, and control a charging state of the second balancing circuit. The balancing controller may control the first switching circuit to connect the positive electrode and the negative electrode of the first energy storage unit to the first side of the first balancing circuit, and control the second switching circuit to connect the positive electrode and the negative electrode of the second energy storage unit to the second balancing circuit. The first energy storage unit is any energy storage unit, in the energy storage apparatus, whose SOC value is greater than the target SOC value, and the second energy storage unit is any energy storage unit, in the energy storage apparatus, whose SOC value is less than the target SOC value. The balancing controller may further control the first balancing circuit to perform discharging processing on the first energy storage unit, and control the second balancing circuit to perform charging processing on the second energy storage unit. For example, the balancing controller may be any one of a microprocessor (for example, a microcontroller unit (MCU)), a general-purpose central processing unit (CPU), a general-purpose processor, a digital signal processor (DSP), an application-specific integrated circuit (ASIC), a field-programmable gate array (FPGA), and the like, or may be any one or a combination of another programmable logic device, a transistor logic device, and a hardware component.

In this disclosure, the energy balancing system is disposed outside the energy storage apparatus. The energy balancing system includes at least two balancing circuits. In a same time period, the first balancing circuit is configured to perform discharging processing on the first energy storage unit, and the second balancing circuit is configured to perform charging processing on the second energy storage unit, to implement energy balancing between energy storage units in the energy storage apparatus. In addition, a switching circuit disposed in the energy balancing system can implement sharing of a balancing circuit between energy storage units, thereby improving utilization of the balancing circuit and reducing energy balancing costs. Moreover, in the energy balancing system, a large-power balancing circuit is used to replace a balancing module disposed in each energy storage unit, so that energy balancing costs can be reduced, balancing power can be increased, and a balancing time can be shortened.

In some embodiments of this disclosure, the first balancing circuit and the second balancing circuit may include a unidirectional DC-DC circuit. In other words, the first balancing circuit implements only a discharging function, and the second balancing circuit implements only a charging function. Alternatively, in some other embodiments of this disclosure, the first balancing circuit and the second balancing circuit may alternatively include a bidirectional DC-DC circuit. For example, functions of the first balancing circuit and the second balancing circuit may be interchanged, to implement the discharging function and the charging function.

In this embodiment of this disclosure, the first switching circuit includes a plurality of pairs of first switches, and a quantity of pairs of first switches is the same as a quantity of energy storage units. One side of a pair of first switches is connected to a positive electrode and a negative electrode of a corresponding energy storage unit, and the other side of the pair of first switches is connected to a positive electrode and a negative electrode of the first side of the first balancing circuit. In a same time period, a pair of first switches is turned on, and other pairs of first switches are turned off. The first balancing circuit discharges, to the balancing busbar, electric energy of the first energy storage unit connected to the turned-on first switches. Similarly, the second switching circuit includes a plurality of pairs of second switches, and a quantity of pairs of second switches is the same as the quantity of energy storage units. One side of a pair of second switches is connected to a positive electrode and a negative electrode of a corresponding energy storage unit, and the other side of the pair of second switches is connected to a positive electrode and a negative electrode of the first side of the second balancing circuit. In a same time period, a pair of second switches is turned on, and other pairs of second switches are turned off. The second balancing circuit uses electric energy on the balancing busbar to charge the second energy storage unit connected to the turned-on second switches.

In some embodiments of this disclosure, when SOC values of a plurality of energy storage units in the energy storage apparatus are all greater than the target SOC value, it may be considered that there are a plurality of energy storage units that need to be discharged in the energy storage apparatus. When SOC values of a plurality of energy storage units in the energy storage apparatus are all less than the target SOC value, it may be considered that there are a plurality of energy storage units that need to be charged in the energy storage apparatus.

In this embodiment of this disclosure, in a discharging process for energy balancing, in a same time period, the first switching circuit is connected to only a positive electrode and a negative electrode of one energy storage unit, namely, the first energy storage unit. Therefore, the first balancing circuit performs discharging processing on only one energy storage unit, namely, the first energy storage unit. When a difference between the SOC value of the first energy storage unit and the target SOC value is less than a first threshold, it indicates that energy of the first energy storage unit has reached a balancing standard, and the first switching circuit may switch to connect a positive electrode and a negative electrode of another energy storage unit, namely, the third energy storage unit, to the first side of the first balancing circuit, so that the first balancing circuit performs discharging processing on the third energy storage unit. An SOC value of the third energy storage unit is greater than the target SOC value.

In some embodiments of this disclosure, in the foregoing discharging process for energy balancing, a discharging priority of the energy storage units may be determined based on differences between the target SOC value and the SOC values of the energy storage units. For example, a larger difference between an SOC value of an energy storage unit and the target SOC value indicates a higher discharging priority of the energy storage unit. In other words, the energy storage unit undergoes an energy balancing operation preferentially. For example, in the foregoing process, the difference between the SOC value of the first energy storage unit and the target SOC value is greater than a difference between the SOC value of the third energy storage unit and the target SOC value. Therefore, the first balancing circuit preferentially performs discharging processing on the first energy storage unit.

After all energy storage units whose SOC values are greater than the target SOC value are discharged until differences between the SOC values and the target SOC value are less than the first threshold, it indicates that energy balancing for all these energy storage units is completed. In this case, the first switching circuit may switch to an off state, for example, the first switching circuit does not connect any energy storage unit to the first side of the first balancing circuit.

In this embodiment of this disclosure, in a charging process for energy balancing, in a same time period, the second switching circuit is connected to only a positive electrode and a negative electrode of one energy storage unit, namely, the second energy storage unit. Therefore, the second balancing circuit performs charging processing on only one energy storage unit, namely, the second energy storage unit. When a difference between the SOC value of the second energy storage unit and the target SOC value is less than a second threshold, it indicates that energy of the second energy storage unit has reached the balancing standard, and the second switching circuit may switch to connect a positive electrode and a negative electrode of another energy storage unit, namely, a fourth energy storage unit, to the first side of the second balancing circuit, so that the second balancing circuit performs charging processing on the fourth energy storage unit. An SOC value of the fourth energy storage unit is less than the target SOC value, and the second threshold may be the same as or different from the first threshold. This is not limited herein.

In some embodiments of this disclosure, in the foregoing charging process for energy balancing, a charging priority of the energy storage units may be determined based on the differences between the target SOC value and the SOC values of the energy storage units. For example, a larger difference between an SOC value of an energy storage unit and the target SOC value indicates a higher charging priority of the energy storage unit. In other words, the energy storage unit undergoes an energy balancing operation preferentially. For Example, in the foregoing process, the difference between the SOC value of the second energy storage unit and the target SOC value is greater than a difference between the SOC value of the fourth energy storage unit and the target SOC value. Therefore, the second balancing circuit preferentially performs discharging processing on the second energy storage unit.

After all energy storage units whose SOC values are less than the target SOC value are charged until differences between the SOC values and the target SOC value are less than the second threshold, it indicates that energy balancing for all these energy storage units is completed. In this case, the second switching circuit may switch to an off state, for example, the second switching circuit does not connect any energy storage unit to the first side of the second balancing circuit.

In some other embodiments of this disclosure, if there are a large quantity of energy storage units connected in series in the energy storage apparatus connected to the energy balancing system, to improve active balancing power and active balancing efficiency, a quantity of balancing circuits can be appropriately increased in the energy balancing system.

For example, the energy balancing system may include a plurality of first balancing circuits and a plurality of first switching circuits, and the first switching circuits and the first balancing circuits are disposed in a one-to-one correspondence. In a time period during active balancing, to improve active balancing power and active balancing efficiency, the balancing controller can simultaneously control different first switching circuits to connect positive electrodes and negative electrodes of different first energy storage units to first sides of corresponding first balancing circuits, and control the corresponding first balancing circuits to perform discharging processing on the different first energy storage units. For example, during active balancing, two first switching circuits may be respectively used to respectively connect two first balancing circuits to two different first energy storage units, and the two first balancing circuits may simultaneously discharge electric energy stored in the two first energy storage units to the balancing busbar. In another time period during active balancing, if required active balancing power and efficiency are low, the balancing controller may alternatively control only one first switching circuit to connect a positive electrode and a negative electrode of one first energy storage unit to a first side of one first balancing circuit, and control one first balancing circuit to perform discharging processing on one first energy storage unit.

For example, the energy balancing system may include a plurality of second balancing circuits and a plurality of second switching circuits, and the second switching circuits and the second balancing circuits are disposed in a one-to-one correspondence. In a time period during active balancing, to improve active balancing power and active balancing efficiency, the balancing controller may simultaneously control different second switching circuits to connect positive electrodes and negative electrodes of different second energy storage units to first sides of corresponding second balancing circuits, and control the corresponding second balancing circuits to perform charging processing on the different second energy storage units. For example, during active balancing, two second switching circuits may be respectively used to respectively connect two second balancing circuits to two different second energy storage units, and the two second balancing circuits may simultaneously discharge electric energy stored in the two second energy storage units to the balancing busbar. In another time period during active balancing, if required active balancing power and efficiency are low, the balancing controller may alternatively control only one second switching circuit to connect a positive electrode and a negative electrode of one second energy storage unit to a first side of one second balancing circuit, and control one second balancing circuit to perform charging processing on one second energy storage unit.

In this disclosure, to simplify charging and discharging management control logic of the balancing controller for different energy storage units, a quantity of first balancing circuits included in the energy balancing system is usually the same as a quantity of second balancing circuits.

Refer to FIG. 4. In some embodiments of this disclosure, the energy balancing system may be further configured as a balancing control box independent of the energy storage apparatus.

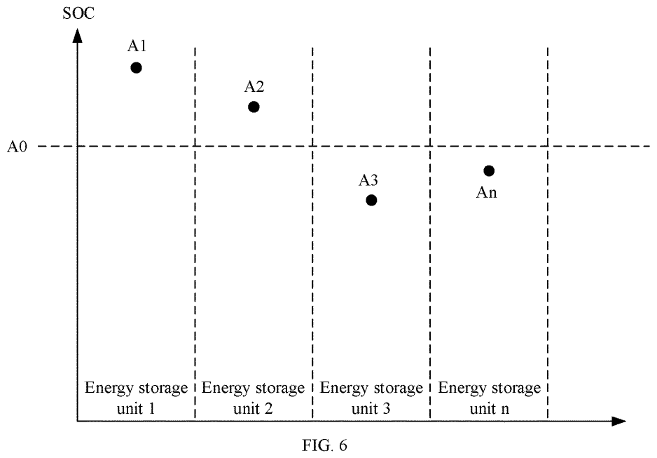

Refer to FIG. 5. In some other embodiments of this disclosure, an energy storage controller, for example, a battery control unit, may be further disposed in the balancing control box, for example, the energy balancing system. The energy storage controller is configured to detect the SOC values of the energy storage units, and may sample a state of charge by using a battery sampling unit disposed in each energy storage unit. The energy storage controller may determine the target SOC value based on the SOC values of the energy storage units, where the target SOC value may be an average of the SOC values of the energy storage units, and the average is also referred to as a median value. The energy storage controller may control a status of the energy storage apparatus based on information such as the SOC values of the energy storage units, for example, may control the energy storage apparatus to be in a charging state, a discharging state, or a standby state. The energy storage controller may further determine differences between the target SOC value and the SOC values of the energy storage units. When some differences are large, for example, greater than a third threshold, for example, an active balancing condition is met, the energy storage controller starts an active balancing procedure. The energy storage controller determines the first energy storage unit and the second energy storage unit from the energy storage units based on the target SOC value, and delivers information about the first energy storage unit and the second energy storage unit to the balancing controller, so that the balancing controller performs an active balancing operation. The first energy storage unit is an energy storage unit whose SOC value is greater than the target SOC value, and the second energy storage unit is an energy storage unit whose SOC value is less than the target SOC value.

For example, the energy controller, for example, the battery control unit, may be any one of an MCU, a general-purpose CPU, a general-purpose processor, a DSP, an ASIC, an FPGA, and the like, or may be any one or a combination of another programmable logic device, a transistor logic device, and a hardware component.

The following describes, by using an embodiment, a working process of the energy balancing system provided in this disclosure.

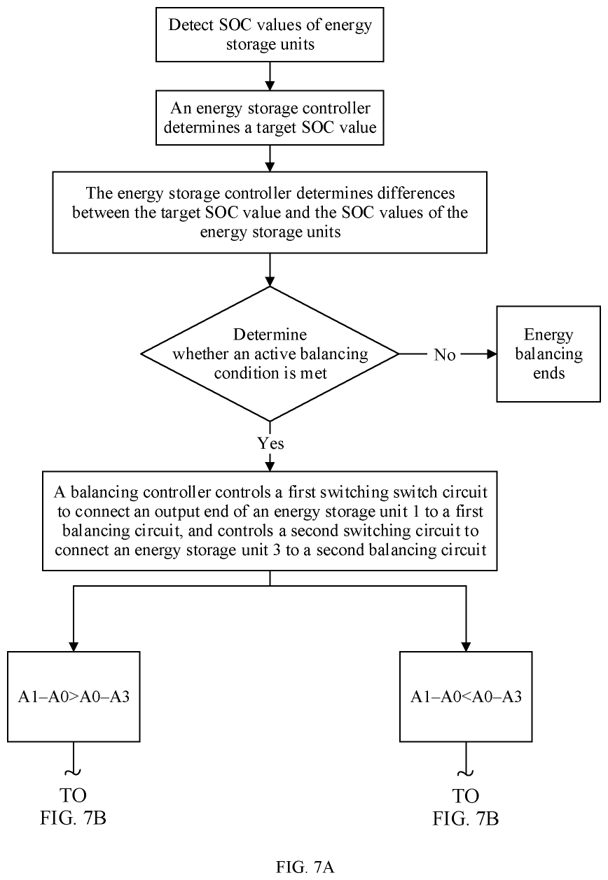

Refer to FIG. 6. An example in which the energy balancing system shown in FIG. 4 is connected to n energy storage units is used. The energy storage controller detects that SOC values of the energy storage units are different. An SOC value of an energy storage unit 1 is A1, an SOC value of an energy storage unit 2 is A2, an SOC value of an energy storage unit 3 is A3, an SOC value of an energy storage unit n is An, and a target SOC value is A0. The energy storage unit 1 may discharge to the balancing busbar through the first balancing circuit, and a total discharge capacity is A1−A0. In addition, the energy storage unit 3 may draw electricity from the balancing busbar through the second balancing circuit, and a total amount of drawn electricity is A0−A3. By analogy, the energy storage unit 2 and the energy storage unit n each draw electricity from or supply electricity to the balancing busbar based on an energy difference that needs to be balanced. In addition, an energy-balanced state may be implemented in a charging state, a standby state, or a discharging state of the energy storage apparatus.

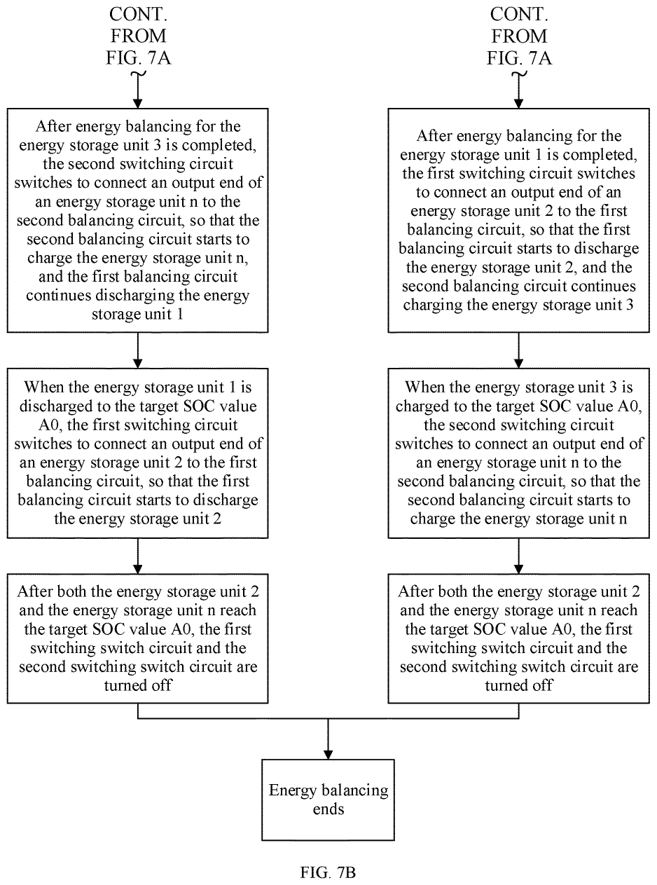

Refer to FIG. 7A and FIG. 7B. An energy balancing process of the energy balancing system is as follows.

The energy storage controller detects the SOC values of the energy storage units and determines that the target SOC value is A0, and then the energy storage controller determines differences between the target SOC value and the SOC values of the energy storage units. Whether an active balancing condition is met is determined. For example, when some differences are large, for example, greater than a third threshold, for example, the active balancing condition is met, the energy storage controller starts the active balancing procedure. The energy storage controller determines, from the energy storage units based on the target SOC value, that the energy storage unit 1 and the energy storage unit 2 are energy storage units that need to be discharged, and the energy storage unit 3 and the energy storage unit n are energy storage units that need to be charged, and delivers the foregoing information to the balancing controller.

The balancing controller controls the first switching circuit to connect an output end of the energy storage unit 1 to the first balancing circuit, and controls the second switching circuit to connect the energy storage unit 3 to the second balancing circuit. The first balancing circuit discharges the energy storage unit 1 by A1−A0, and the second balancing circuit charges the energy storage unit 4 by A0−A3.

When the balancing controller determines that A1−A0>A0−A3, the energy storage unit 3 completes energy balancing, for example, reaches the target SOC value, before the energy storage unit 1. After the energy storage unit 3 completes energy balancing and when the energy storage unit 1 does not complete energy balancing, the second switching circuit switches to connect an output end of the energy storage unit n to the second balancing circuit, so that the second balancing circuit starts to charge the energy storage unit n, and the first balancing circuit continues discharging the energy storage unit 1. When the energy storage unit 1 is discharged to the target SOC value A0, the first switching circuit switches to connect an output end of the energy storage unit 2 to the first balancing circuit, so that the first balancing circuit starts to discharge the energy storage unit 2. After both the energy storage unit 2 and the energy storage unit n reach the target SOC value A0, the first switching circuit and the second switching circuit are turned off to complete energy balancing.

When the balancing controller determines that A1−A0<A0−A3, the energy storage unit 1 completes energy balancing, for example, reaches the target SOC value, before the energy storage unit 3. After the energy storage unit 1 completes energy balancing and when the energy storage unit 3 does not complete energy balancing, the first switching circuit switches to connect the output end of the energy storage unit 2 to the first balancing circuit, so that the first balancing circuit starts to discharge the energy storage unit 2, and the second balancing circuit continues charging the energy storage unit 3. When the energy storage unit 3 is charged to the target SOC value A0, the second switching circuit switches to connect the output end of the energy storage unit n to the second balancing circuit, so that the second balancing circuit starts to charge the energy storage unit n. After both the energy storage unit 2 and the energy storage unit n reach the target SOC value A0, the first switching circuit and the second switching circuit are turned off to complete energy balancing.

This disclosure further provides an energy storage system. The energy storage system may include the energy balancing system and the energy storage apparatus that are provided in embodiments of this disclosure. The energy storage apparatus includes a plurality of energy storage units connected in series. Positive electrodes and negative electrodes of the energy storage units are respectively connected to a first switching circuit and a second switching circuit in the energy balancing system.

The energy storage system provided in this embodiment of this disclosure may be a commercial power station energy storage system, or may be a scenario that has a battery requirement, such as an industrial and commercial energy storage system, a residential energy storage system, a power station energy storage system, or a charging station energy storage system. In addition, this disclosure is applicable to various forms of batteries such as a lithium-ion battery, a sodium-ion battery, and a magnesium-aluminum battery.

In some embodiments of this disclosure, the system may be applied to active balancing at a battery pack level. Correspondingly, the energy storage apparatus may be a battery cluster, and the energy storage unit is a battery pack, for example, a plurality of battery packs connected in series form a battery cluster. The energy balancing system provided in this embodiment of this disclosure is disposed outside the battery pack, and the energy balancing system can implement energy balancing between battery packs.

In some other embodiments of this disclosure, the system may be applied to active balancing at a cell level. Correspondingly, the energy storage apparatus may be a battery pack, and the energy storage unit is a cell, for example, a plurality of cells connected in series form a battery pack. The energy balancing system provided in this embodiment of this disclosure is disposed outside a cell, and the energy balancing system can implement energy balancing between cells.

It is clearly that a person skilled in the art can make various modifications and variations to this disclosure without departing from the spirit and scope of this disclosure. This disclosure is intended to cover these modifications and variations of this disclosure provided that they fall within the scope defined by the claims of this disclosure and their equivalent technologies.

What is claimed is:

1. An energy balancing system comprising:
a first balancing circuit comprising a first side and a second side and configured to perform first discharging processing on a first energy storage unit of energy storage units of an energy storage apparatus;
a second balancing circuit comprising a third side and a fourth side and configured to perform first charging processing on a second energy storage unit of the energy storage units;
a first switching circuit connected to the first side and configured to connect a first positive electrode of the first energy storage unit and a first negative electrode of the first energy storage unit to the first side;
a second switching circuit connected to the third side and configured to connect a second positive electrode of the second energy storage unit and a second negative electrode of the second energy storage unit to the third side; and
a balancing busbar connected to the second side and the fourth side.

2. The energy balancing system of claim 1, wherein when a first difference between a first state of charge (SOC) value of the first energy storage unit and a target SOC value is less than a first threshold:
the first switching circuit is further configured to connect a third positive electrode of a third energy storage unit of the energy storage units and a third negative electrode of the third energy storage unit to the first side, and
the first balancing circuit is further configured to perform second discharging processing on the third energy storage unit.

3. The energy balancing system of claim 1, wherein when a difference between a state of charge (SOC) value of the second energy storage unit and a target SOC value is less than a threshold:
the second switching circuit is further configured to connect a third positive electrode of a third energy storage unit of the energy storage units and a third negative electrode of the third energy storage unit to the third side, and
the second balancing circuit is further configured to perform second charging processing on the third energy storage unit.

4. The energy balancing system of claim 1, further comprising:
a third balancing circuit comprising a fifth side and configured to perform second discharging processing on a third energy storage unit of the energy storage units; and
a third switching circuit connected to the fifth side and configured to connect to a third positive electrode of the third energy storage unit and a third negative electrode of the third energy storage unit to the fifth side.

5. The energy balancing system of claim 1, further comprising:
a third balancing circuit comprising a fifth side and configured to perform second charging processing on a third energy storage unit of the energy storage units; and
a third switching circuit connected to the fifth side and configured to connect to a third positive electrode of the third energy storage unit and a third negative electrode of the third energy storage unit to the fifth side.

6. The energy balancing system of claim 1, wherein the first balancing circuit further comprises a first unidirectional direct current-direct current (DC-DC) circuit, and wherein the second balancing circuit further comprises a second unidirectional DC-DC circuit.

7. The energy balancing system of claim 1, wherein the first balancing circuit further comprises a first bidirectional direct current-direct current (DC-DC) circuit, and wherein the second balancing circuit further comprises a second bidirectional DC-DC circuit.

8. The energy balancing system of claim 1, further comprising a balancing controller configured to:
control on and off states of the first switching circuit and the second switching circuit;
control a discharging state of the first balancing circuit; and
control a charging state of the second balancing circuit.

9. The energy balancing system of claim 1, further comprising an energy storage controller configured to:
detect state of charge (SOC) values of the energy storage units;
determine a target SOC value based on the SOC values; and
determine the first energy storage unit and the second energy storage unit from the energy storage units based on the target SOC value.

10. An energy storage system comprising:
an energy storage apparatus comprising energy storage units connected in series, wherein the energy storage units comprise:
a first energy storage unit comprising a first positive electrode and a first negative electrode; and
a second energy storage unit comprising a second positive electrode and a second negative electrode; and
an energy balancing system configured to balance energy of the energy storage apparatus and comprising:
a first balancing circuit comprising a first side and a second side and configured to perform first discharging processing on the first energy storage unit;
a second balancing circuit comprising a third side and a fourth side and configured to perform first charging processing on the second energy storage unit;
a first switching circuit connected to the first side and configured to connect the first positive electrode and the first negative electrode to the first side;
a second switching circuit connected to the third side and configured to connect the second positive electrode and the second negative electrode to the third side; and
a balancing busbar connected to the second side and the fourth side.

11. The energy storage system of claim 10, wherein the energy storage apparatus is a battery cluster, and wherein the energy storage units are battery packs.

12. The energy storage system of claim 10, wherein the energy storage apparatus is a battery pack, and wherein the energy storage units are cells.

13. The energy storage system of claim 10, wherein the first energy storage unit is configured to have a first state of charge (SOC) value greater than a target SOC value, and wherein the second energy storage unit is configured to have a second SOC value less than the target SOC value.

14. The energy storage system of claim 13, wherein the energy storage apparatus further comprises a third energy storage unit, wherein the third energy storage unit comprises a third positive electrode and a third negative electrode, and wherein when a first difference between the first SOC value and the target SOC value is less than a first threshold:
the first switching circuit is further configured to connect the third positive electrode and the third negative electrode to the first side, and
the first balancing circuit is further configured to perform second discharging processing on the third energy storage unit.

15. The energy storage system of claim 14, wherein the third energy storage unit is configured to have a third SOC value greater than the target SOC value, and wherein the first difference is greater than a second difference between the third SOC value and the target SOC value.

16. The energy storage system of claim 13, wherein the energy storage apparatus further comprises a third energy storage unit, wherein the third energy storage unit comprises a third positive electrode and a third negative electrode, and wherein when a first difference between the second SOC value and the target SOC value is less than a second threshold:
the second switching circuit is further configured to connect the third positive electrode and the third negative electrode to the third side, and
the second balancing circuit is further configured to perform second charging processing on the third energy storage unit.

17. The energy storage system of claim 10, wherein the first balancing circuit further comprises a first unidirectional direct current-direct current (DCDC) circuit, and wherein the second balancing circuit further comprises a second unidirectional DCDC circuit.

18. The energy storage system of claim 10, wherein the first balancing circuit further comprises a first bidirectional direct current-direct current (DCDC) circuit, and wherein the second balancing circuit further comprises a second bidirectional DCDC circuit.

19. The energy storage system of claim 10, further comprising a balancing controller configured to:
control on and off states of the first switching circuit and the second switching circuit;
control a discharging state of the first balancing circuit; and
control a charging state of the second balancing circuit.

20. An energy balancing system comprising:
a first balancing circuit comprising a first side and a second side and configured to perform first discharging processing on a first energy storage unit of energy storage units of an energy storage apparatus;
a second balancing circuit configured to perform charging processing on a second energy storage unit of the energy storage units, wherein the second balancing circuit comprises:
a third side; and
a fourth side connected to the second side;
a first switching circuit connected to the first side and configured to connect a first positive electrode of the first energy storage unit and a first negative electrode of the first energy storage unit to the first side; and
a second switching circuit connected to the third side and configured to connect a second positive electrode of the second energy storage unit and a second negative electrode of the second energy storage unit to the third side.
